(19) United States
(12) Patent Application Publication
(10) Pub. No.: US 2022/0124996 A1
(43) Pub. Date: Apr. 28, 2022

(54) HYDROPONIC SYSTEMS AND METHODS AND GROWING CASSETTES THEREFOR

(71) Applicant: PALRAM 4U LTD, Natsrat llit (IL)

(72) Inventors: Yuval SHAMIR, Hagoshrim (IL); Tal ARNON, Kiryat Tivon (IL); Guwan BARANSI, Reineh Village (IL)

(21) Appl. No.: 17/434,748

(22) PCT Filed: Mar. 3, 2020
(86) PCT No.: PCT/IB2020/051799

§ 371 Date: Aug. 29, 2021

Related U.S. Application Data
(60) Provisional application No. 62/814,304, filed on Mar. 6, 2019.

(51) Int. Cl. A01G 31/06

(52) U.S. Cl. CPC A01G 31/06; A01G 2031/006

(57) ABSTRACT

A cassette for supporting hydroponic growth of plants has an inlet, an outlet and a flow path that extends between the inlet and outlet. The inlet and outlet are located at a similar gating side of the cassette generally adjacent one to the other.

### TECHNICAL FIELD

Embodiments of the invention relate to hydroponic systems and method and to growing cassettes therefor, in particular of types utilizing a flow solution for growth of plants.

### BACKGROUND

In hydroponics, plants are typically grown using mineral nutrient solutions in a water solvent, where roots of growing plants are exposed to the mineral solution. Nutrients used in hydroponic systems may come from an array of sources, and may be provided to plants in various techniques, such as a continuous-flow solution culture technique, where nutrient solution is arranged to constantly flow past the roots.

Indoor hydroponics gardening, which can make use of artificial lighting—may permit users of such systems to grow their own plants, such as vegetables or the like. Growing plants at home may provide various benefits—such as environmental benefits of avoiding shipment of crops to places where agriculture is difficult or impossible to perform—or where certain foods cannot be grown due to shorter growing seasons.

U.S. Pat. No. 4,676,023 describes a cultivation device that makes use of water-and-air mixture that includes an air pump, a water guiding tube, a lever mechanism for storing culture fluid emitted from the water guiding tube, and cultivation pallets by use of water-and-air mixture, which are installed in an inclined state and supplied with the culture fluid discharged from the lever mechanism.

JP2013099262 describes a hydroponic device that includes cultivation containers that are arranged in a vertical stack, with some of the containers being of a kind that includes mountain fold-like containers and others of a kind that includes valley fold-like containers both inclined to form a downward directed flow pattern between the containers.

US2017223904 describes a growing apparatus that includes an insulated housing with a closable door. The apparatus further includes a plurality of vertically-spaced platforms that are inclined downwards. An illumination system of the apparatus includes a LED equipped lighting assembly supported over each of the platforms.

### SUMMARY

The following embodiments and aspects thereof are described and illustrated in conjunction with systems, tools and methods which are meant to be exemplary and illustrative, not limiting in scope.

In an embodiment there is provided a cassette for supporting hydroponic growth of plants, the cassette comprising an inlet, an outlet and a flow path communicating between the inlet and outlet for irrigating plants, wherein the inlet and outlet are arranged at a similar gating side of the cassette generally adjacent one to the other.

Provision of inlet and outlet at a similar cassette side may permit in at least certain embodiments efficiency of both cassette placement adjacent to each other and/or in a system housing a plurality of such cassettes, and/or efficient flow path regime between such cassettes, in particular between cassettes placed one on top of the other.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows a hydroponic system in accordance with an embodiment of the present invention;

FIG. 2A schematically shows a perspective view of an embodiment of a cassette for growing plants that may possibly be used in a hydroponic system such as that shown in FIG. 1 or those shown in FIG. 13;

FIG. 2B schematically shows a cross section of the cassette of FIG. 2A taken in plane II-II marked in FIG. 2A;

FIG. 3A schematically shows a stack of cassettes generally similar to those illustrated in FIG. 2;

FIG. 3B schematically shows a cross sectional view of the stack of cassettes of FIG. 3A;

FIG. 4 schematically shows a close view of an embodiment of a cassette for growing plants;

FIGS. 5 and 12 schematically shows cassette embodiments generally similar to those shown in figures of the present disclosure, illustrating provision of possible modularity within cassette(s) for adapting to different growth phases of plants;

FIG. 6 schematically shows a close view of a cross section of a cassette according to an embodiment of the present invention;

FIG. 7 schematically shows a cross sectional view of an embodiment of a cassette of the present invention;

FIGS. 8 to 14 schematically show views of additional cassette embodiments of the present invention;

FIGS. 15 and 16 schematically shows views of various hydroponic system embodiments that may make use of various embodiments of cassettes for growing plants as described herein;

FIGS. 17A to 17D schematically show various views of an embodiment of a cassette of the present invention;

FIG. 18 schematically shows a further embodiment of a cassette of the present invention; and

FIG. 19 schematically shows a hydroponic system embodiment that may make use of various embodiments of cassettes for growing plants as described herein.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

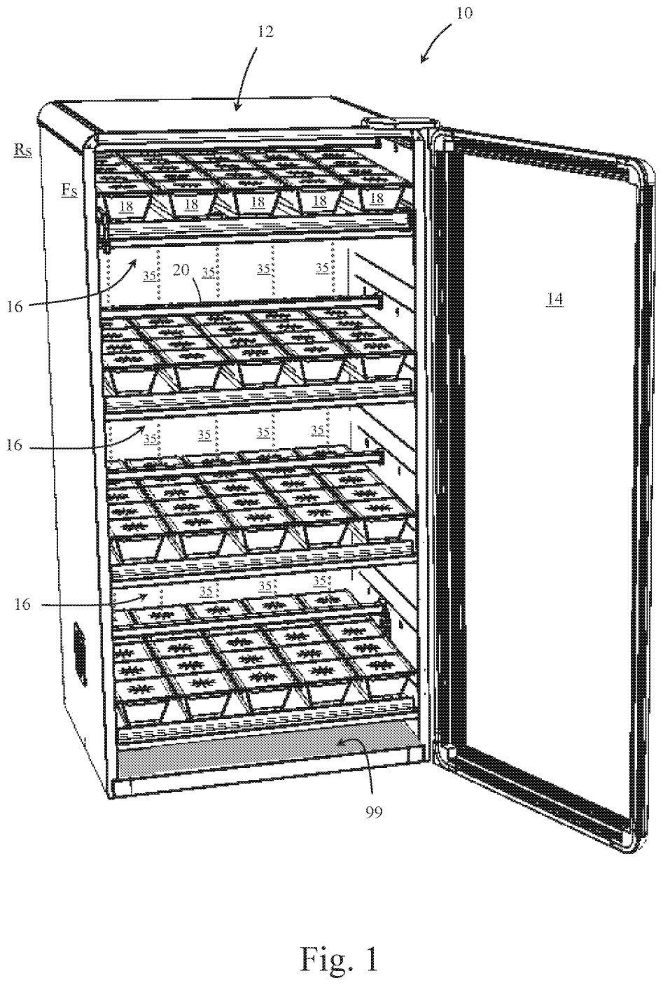

Attention is first drawn to FIG. 1 illustrating an embodiment of a hydroponic system 10 of the present invention. System 10 in the illustrated example may be seen including a closet-like cabinet 12 and a closable door 14, in this example hinged to a side wall of the cabinet—for closing and opening a forward open side of the cabinet. Directional tem ins defining respective forward F_{S} and rear R_{S} sides of system 10 are indicated in FIG. 1.

Hydroponic system(s) according to the disclosed embodiments, such as hydroponic system 10, may be adapted for use in various environments, such as industrial, semi-industrial, and preferably residential environments. For example, at least certain embodiments may be envisioned for use within, or adjacent to, a dwelling (e.g. an apartment) permitting growth of plants or vegetation for consumption by individuals residing within or adjacent such dwelling.

Possibly, at least certain hydroponic system embodiments, may be modular in the sense of permitting manual assembly within the intended environment of use. Additional modularity permitting re-arrangement of an interior of the system housing plants or within growing cassettes supporting growth of such plants may be provided (as will be exemplified herein below)—to possibly support different growth phases and/or re-occurring growth cycles/patterns of plants nurtured within such system(s) and/or cassettes.

An aspect of certain embodiments—possibly associated also to modularity but not only—may be seen in provision of ease of maintenance to systems and/or system elements. Such ease of maintenance may be manifested e.g. in the facilitating of disinfection and/or cleaning processes to elements of a system—such as to growing cassettes. In certain embodiments—elements (e.g. cassettes) may be formed of materials (e.g. polypropylene) suitable for undergoing disinfection and/or cleaning processes. For example, a cassette and/or parts of a cassette for growing plants (e.g. receptacles, lids, etc.) may be suitably sized and/or formed to be inserted into available cleaning appliances of users of such systems—e.g. in a dish-washing appliance when considering a residential environment.

Cabinet 12 may be formed from materials (e.g. plastic materials) and/or structure—that may be designed to substantially block light from entering into or exiting out of the cabinet—in order to substantially prevent or reduce algae or fungal growth within the cabinet (e.g. within nutrient solution in the cabinet) and/or to preserve light/radiation within the system aimed at assisting plant growth. Such preservation of light/radiation may be assisted by interior faces of a system's cabinet being arranged to reflect outgoing directed light/radiation back into an interior of the cabinet where plants are located.

Door 14 may be formed material or structure possibly also suitable to substantially block light from entering into the cabinet and/or exiting out of the cabinet. In certain embodiments, door 14 may be formed from materials that may be adapted to become transparent upon proximity e.g. of an individual to the door/system—and/or door 14 may be provided with a closable window permitting a view of an interior of the cabinet.

In at least certain embodiments, interior faces of a cabinet may accordingly be arranged to induce diffused reflected light patters within the cabinet, e.g. by being arranged to have or include rough surfaces such as granular type surfaces and/or by being formed from compounds that include white pigment.

In at least certain embodiments, panels used in certain system embodiments and/or in growing cassette embodiments may be layered to include layers arranged to block light from passing therethrough, and layers arranged to induce reflected light to bounce back off such panels.

Layers suitable for blocking passage of light may be layers that absorb light, e.g. by including or being formed of black pigment color. Layers suitable for reflecting light may e.g. be formed or include white pigment color. For example, at least certain cassette embodiments may be designed to include side faces (such as 221, 222, 223, 224) that include several layers (e.g. two or more).

An outer layer exposed to the exterior of a cassette may be arranged to reflect light/radiation, while an additional layer concealed below such outer layer may be arranged to absorb light—and thus reduce light/radiation from entering an interior of a cassette—where same may induce growth of undesired biological matter, such as algae (or the like).

Hydroponic system 10 here includes within cabinet 12 a plurality of shelf formations 16—each including or formed of a plurality of growing cassettes 18. Each shelf may be movable together cassettes that may be removably fitted/mounted thereto. Above each shelf and/or group of cassettes, may be provided one or more light sources 20 for stimulating plant growth by emitting light/radiation appropriate for photosynthesis and/or growth requirements (e.g., temperature) of plants growing within a region (e.g., shelf) of the system. In some cases, such light source 20 may be absent above certain cassettes, such as in cassettes housing seeds during germination or sprouting phases.

In at least certain embodiments, cassettes may also be accordingly formed from materials (e.g. plastic materials) and/or structure—that may be designed to substantially block light from entering into the cassette—in order to substantially prevent or reduce undesired algae or fungal growth within such cassettes (e.g. within nutrient solution within cassettes).

In an aspect of the present invention—a hydroponic system, such as system 10, may be modular to permit easy assembly and flexible arrangement or re-arrangement of elements within the cabinet. For example, a hydroponic system, such as system 10, may permit easy assembly and flexible arrangement or re-arrangement of shelves, cassettes and/or light sources within a cabinet.

Such modularity may permit an individual utilizing a hydroponic system embodiment, such as system 10, to perform or consider manual adjustments to positions of elements such as shelves, cassettes (or the like) within the system. For example, the number and location of shelves may be adjusted and/or the number and/or spacing between cassettes within a shelf may be adjusted—in order to adjust a system to changing growth patterns or conditions within the system.

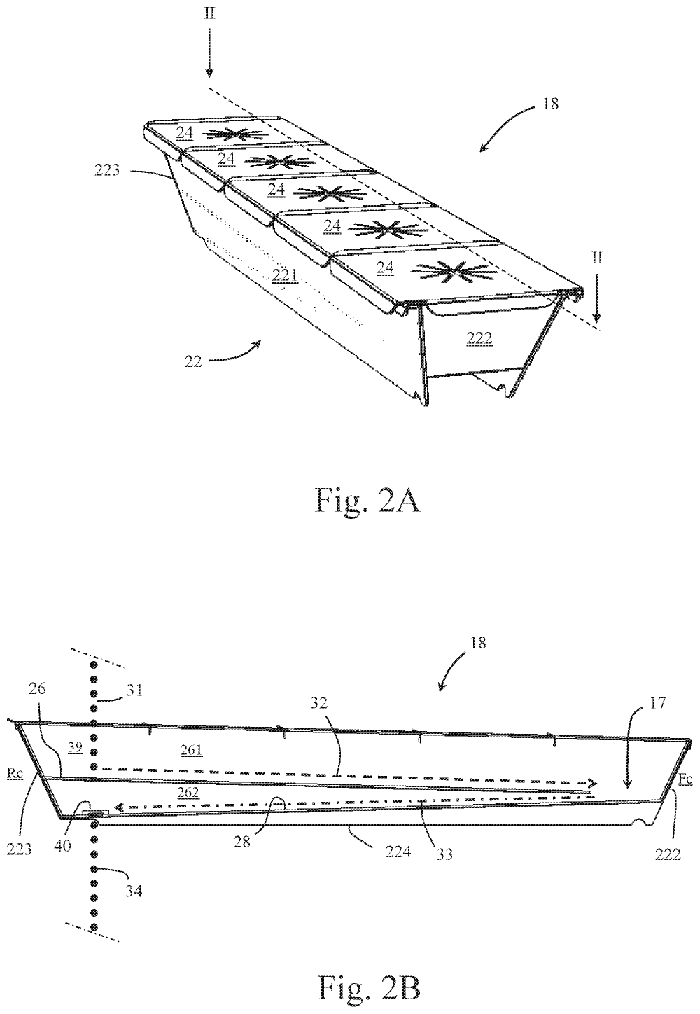

Attention is drawn to FIG. 2A illustrating an embodiment of a growing cassette 18. Cassette 18 in this example is shown including a ‘gutter’ or ‘window-box’-like housing 22. Housing 22 may include a pair of opposing lateral side faces 221 (only side face at a near side being visible) and two opposing front and rear faces 222, 223. Cassette 18 in addition may be arranged to include a bottom face 224 at a lower side (see indicated in FIG. 2B) and in this example removable tops 24 mounted on top of an upper open side of the housing—where possibly such tops may be positioned above receptacles (here not visible) that may be located beneath for supporting plants.

Attention is additionally drawn to FIG. 2B illustrating a cross section of a growing cassette generally similar to that illustrated in FIG. 2A. Here, a possible aspect of the present invention may be embodied revealing possible flow paths formed through a growing cassette and consequently through a hydroponic system, such as system 10. Such flow paths may typically be for liquid, such as flow solution suitable for growth of plants.

In the cross section of FIG. 2B, cassette 18 may be defined as including a rear side R_{C} adjacent rear face 223 and a front side F_{C} adjacent front face 222. In at least certain embodiments of the present invention, cassettes may be arranged to be located within a hydroponic system, such as system 10—with their rear R_{C} and forward F_{C} sides being generally aligned with rear, respective, R_{S} and front F_{S} sides of a hydroponic system in which they are fitted.

Cassette 18 in this embodiment may include a partition 26 and a floor 28 forming two terrace-like formations. Partition 26, that may be formed from materials suitable for absorbing light, may here extend from rear face 223 up to adjacent front face 222 leaving a gap 17 formed between a front edge of the partition and front face 222. Partition 26 in addition may be seen generally dividing an internal cavity of the cassette bound between faces 221, 222, 223 and 224 into upper and lower cavity regions 261, 262. Floor 28 is located below partition 26 and bounds and extends along a lower side of the cavity formed within cassette 18.

When cassette 18 is fitted in its intended position and/or orientation within a hydroponic system, partition 26 may be arranged to extend forwardly while slanting slightly downwards and floor 28 may be arranged to extend rearwardly while slanting slightly downwards in an opposing slant direction to partition 26. Consequently, partition 26 and floor 28 may be seen here forming opposing back and forth slanting paths or routes for liquid flowing through such cassette.

In an embodiment of the present invention, such flow path through the cassette may be defined as including an incoming flow segment 31 dropping and/or entering into an entry 39 of the cassette at a rear portion of upper cavity region 261 adjacent a rear side of the cassette. From there, the flow path may be seen (see ‘dashed’ line) progressing downstream in a transverse direction along a first inclined segment 32 extending here forwardly and slightly downwards along partition 26 until reaching gap 17.

The flow path may then progress downstream through gap 17 to flow backwards along a second opposite inclined segment 33, here in a rear direction (see ‘dash-dotted’ line), along the slanting floor 28 to an exit 40 of the cassette formed through floor 224 adjacent rear face 223. From exit 40, an outgoing flow segment 34 may be formed along a route generally falling downwards and out of the cassette. Thus first inclined segment 32 may be seen located at a relative higher level than the second inclined segment 33, while overlaying the second inclined segment at least along most of its route.

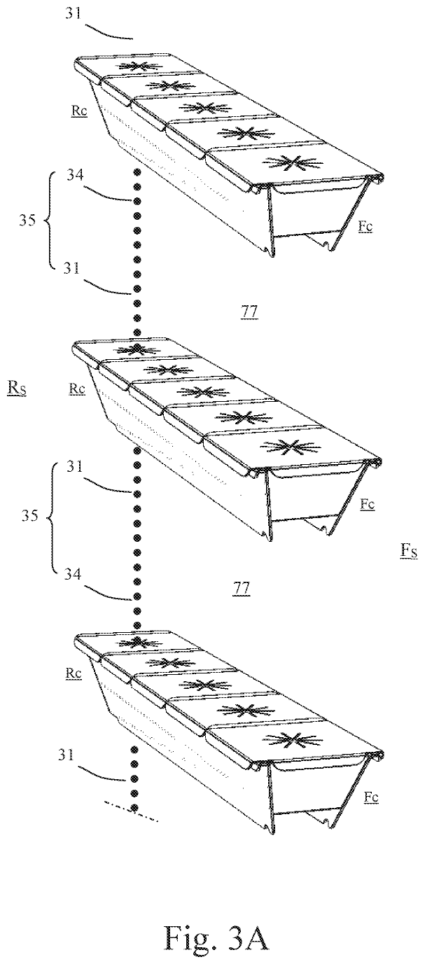

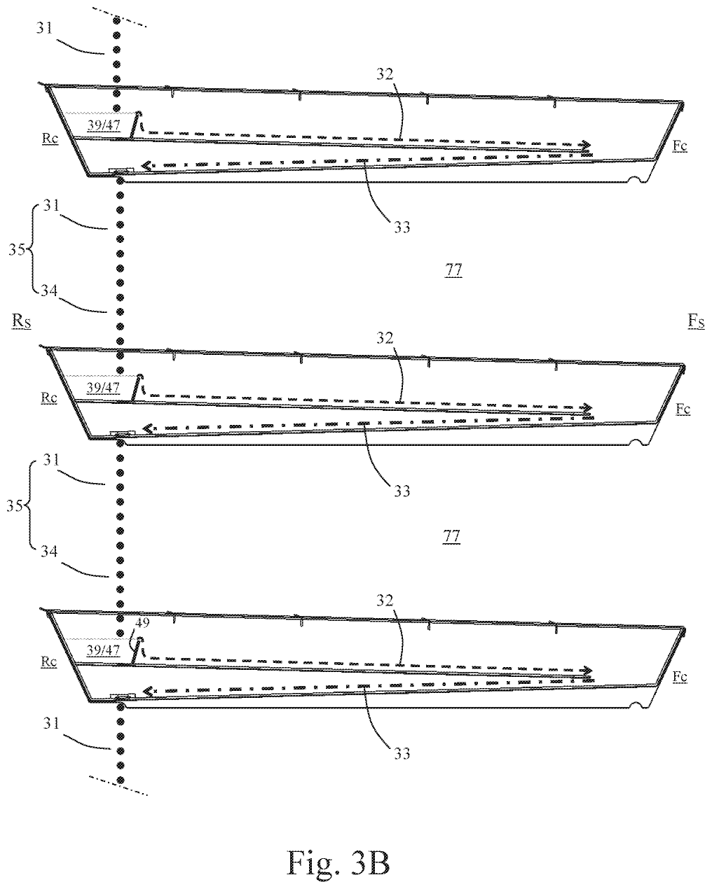

Attention is additionally drawn to FIGS. 3A and 3B illustrating a possible cascade of liquid flow paths that may be formed between adjacently vertically stacked cassettes of a hydroponic system, such as system 10. As here seen, an incoming flow segment 31 enters an entry 39 of each cassette that is located at a relative rear side R_{C} of the cassette.

From there, the liquid path continues downstream along first inclined segment 32 in a general forward direction and then returns back along second inclined segment 33 in a general rear direction to exit the cassette along a downwardly directed outgoing flow segment 34—which in turn forms and/or is also the incoming flow segment 31 entering an adjacently below located cassette. Thus, outgoing and incoming segment may be seen as providing vertical flow paths 35 bridging vertically adjacent cassettes.

Embodiments where rear R_{C} and forward F_{C} sides of cassettes may be aligned, respectively, with rear R_{S} and forward F_{S} sides of a system—may be useful in locating such vertical flow paths 35 at a relative rear side of the system—while leaving empty spaces 77 between vertically stacked cassettes and/or shelves. Such spaces 77 extending forwardly from a rear side of a hydroponic system may be useful in providing unobstructed spaces for plant growth, while permitting substantially free access from a forward open side of the system for maintenance, nurturing and/or harvesting of an interior of the system's cabinet by a user/grower.

Attention is momentarily drawn back to FIG. 1 for a more complete view of one option of liquid flow pattern or cycle extending through a hydroponic system, such as system 10. System 10 may be provided at its bottom with a basin 99 receiving liquid flowing down and downstream between cassettes. In basin 99, monitoring of the liquid flowing through the system may be executed, e.g. of parameters, such as: EC, conductivity, PH (or the like).

Additives may be added to the liquid within basin 99 according to growth requirements or recommendations, possibly by a controller included or in association with the system. Liquid may then be pumped upwards to an upper side of the system—to then flow inter alia, by gravitational forces back towards basin 99 through vertically adjacent or spaced apart cassettes.

In a possible aspect of the present invention, at least certain cassette embodiments may be provided with one or more liquid reservoirs located along a route of a liquid flow path passing therethrough. Such reservoir(s) may be useful in several ways—such as by providing so-called backup “liquid supplies” that may be used for plant irrigation within a cassette in an event that liquid flow through the cassette is stopped, e.g. due to electrical shut down (or the like).

FIG. 3B illustrated provision of such reservoirs 47 at a region of the entry into a cassette. Here a wall like formation 49 may be formed to accumulate in each cassette in a region upstream to the wall liquid forming reservoir 47. As liquid in the reservoir rises and overflows, it can flow downstream through the cassette.

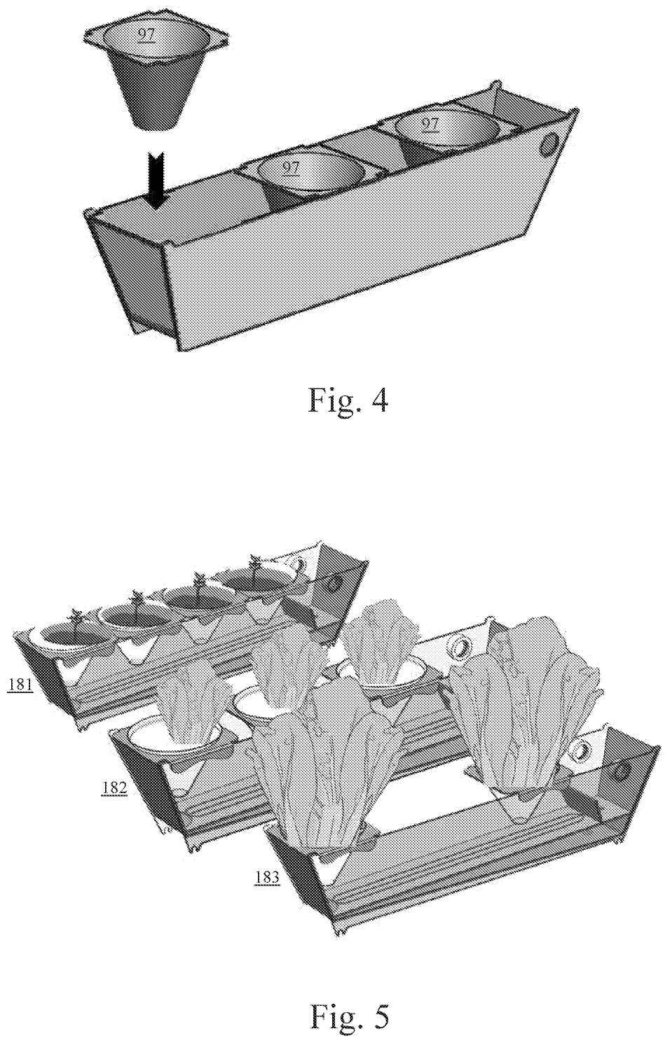

Attention is drawn to FIGS. 4, 5 and 12 for further details on modularity that may be embedded within cassettes in at least certain embodiments. FIG. 4 illustrates a cassette embodiment including removable receptacles 97 that may be manually inserted or removed from the cassette. Such receptacles may also be movable along a cassette to form different spacings between plants growing within such receptacles during their different growth stages.

FIG. 5 exemplifies different growth stages of plants within cassettes and modular adjustment that may be formed to cassettes to accommodate plants e.g. as they grow in size. Cassettes 181, 182, 183 shown in this figure may exemplify different cassettes or the same cassette as it is adjusted to accommodate plant growth.

FIG. 12 similarly exemplifies different growth stages of plants and possible adjustments that may be performed to cassettes to accommodate such growth. Exemplified in this figure may also be seen possible provision of lid members 74 that may be fitted in between receptacles 97 as such receptacles may be re-positioned along a cassette (or possibly removed) to support plant growth demands.

Provision of such lid members, possibly in conjunction with receptacles, may be useful in providing substantially covering or concealing an open side of a cassette. This may in turn be useful in some cases in reducing evaporation and consequent loss of liquid out such cassettes.

Such lid members or receptacles may be formed from materials that substantially absorb light—in order to possibly reduce or limit light from entering into the cassettes. In addition, the cassette configuration at the far side of this view may be seen arranged to accommodate a “zero” number plants, and thus includes lid members along its entire upper opening. The subsequent cassette configuration may be arranged as seen to accommodate a “single” plant—possibly in a mature stage of growth. The next cassette configuration may be seen suited to accommodate three plants and the closest cassette configuration five plants.

A possible aspect of the present invention relates to increasing and/or assisting in the charging of oxygen into liquid flowing through at least certain cassette embodiments of systems—which in certain cases may be preferable for optimal growth conditions of plants growing in such cassettes.

Such charging of oxygen may be increased and/or assisted in embodiments of the present invention by provision of down falling liquid flows, such as flow segment 31, 34—that may be designed to fall down between cassettes possibly within conduits surrounding such flow segments along some or most of their route—or in some cases by such flow segments freely falling down between cassettes not necessarily within conduits.

Such down falling “waterfall” like liquid segments 31, 34 may enhance oxygen charging by increasing exposure of liquid to surrounding oxygen available in ambient air present in between cassettes and/or by spray patterns that may be formed in the liquid as it impacts a cassette that it enters or liquid present within such cassette, e.g., at a cassette's entry 39.

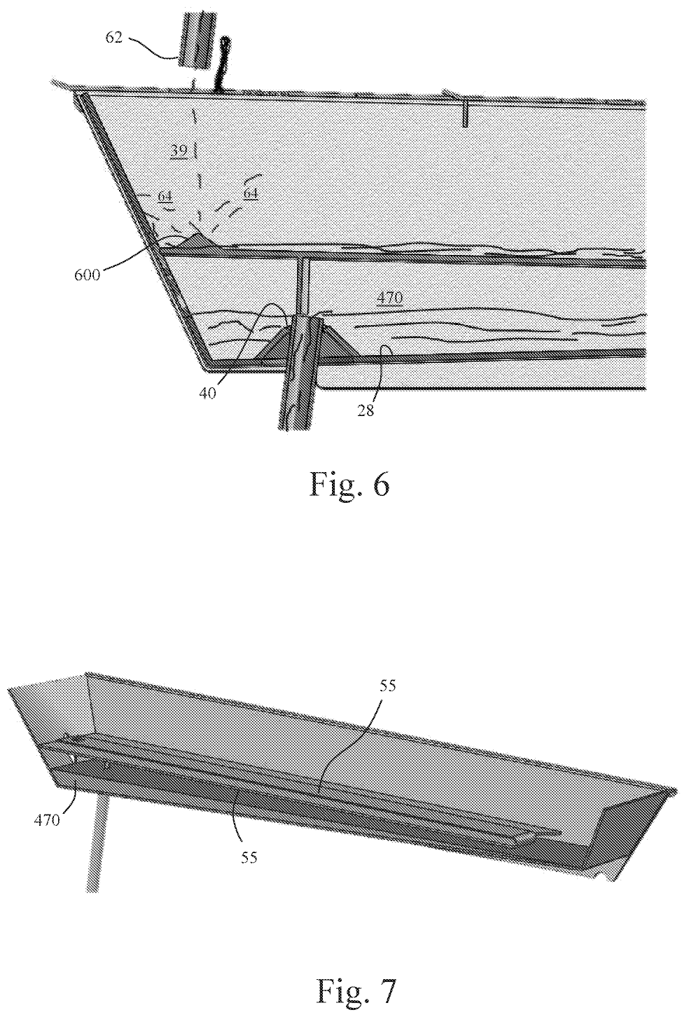

In at least certain embodiments, interference members may be placed in cassettes, such as in entries of cassettes, for increasing formation of such spray or fountain patterns in liquid for purpose of oxygen charging. With attention drawn to FIG. 6, an example of such interference member 600 here placed at an entry 39 of a cassette may be seen embodied as a bulging, possibly upward tapering-like, formation.

In this example, an incoming liquid segment, here seen falling down into a cassette via a possible conduit 62, may be arranged to impact interference member 600 to form spray patterns 64 that may increase exposure to air present within the cassette and consequently to oxygen present therein.

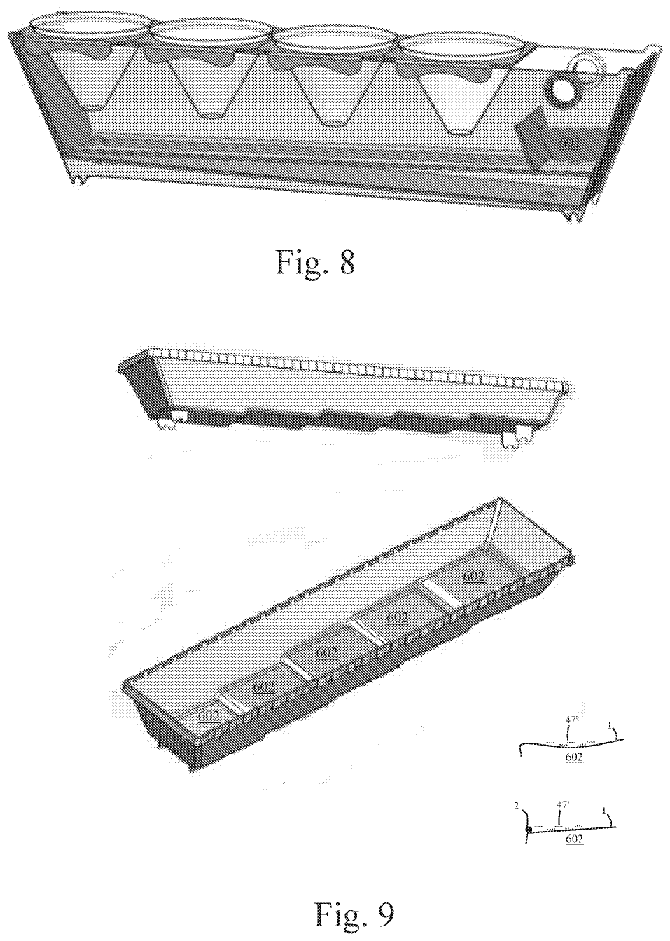

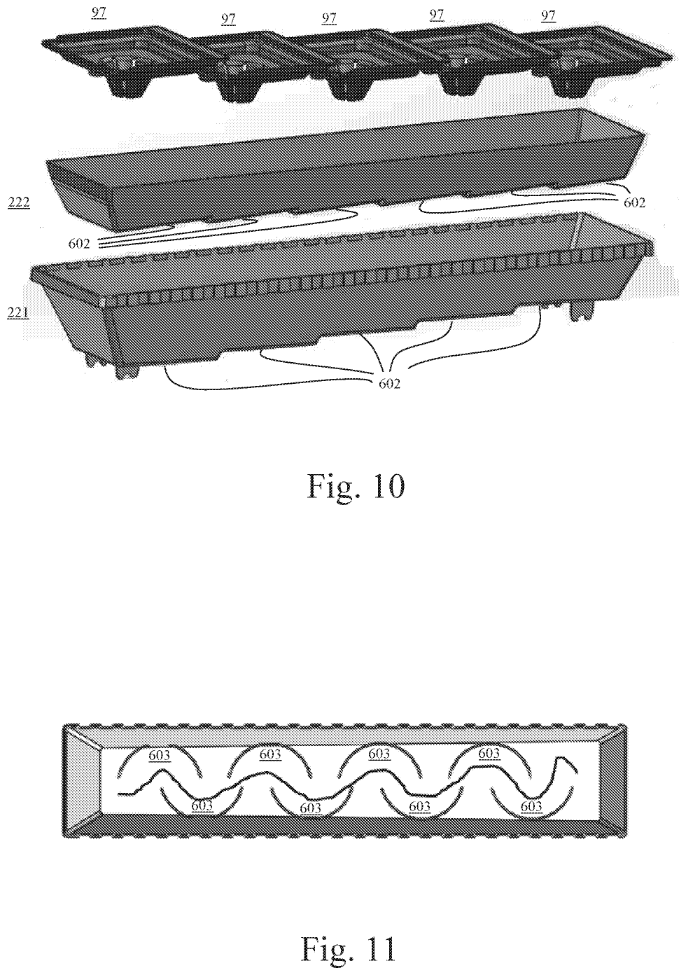

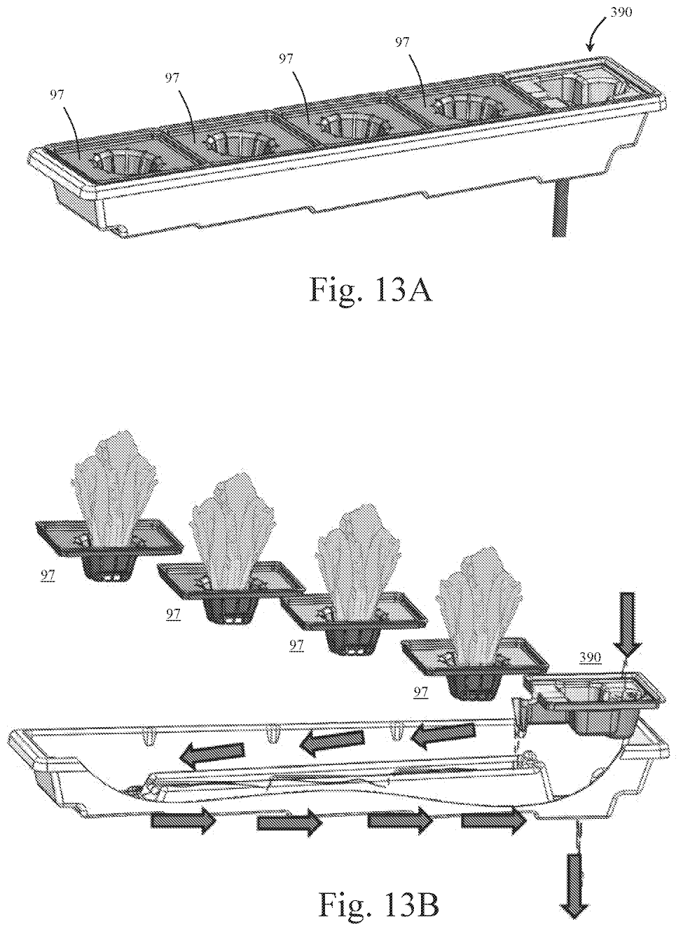

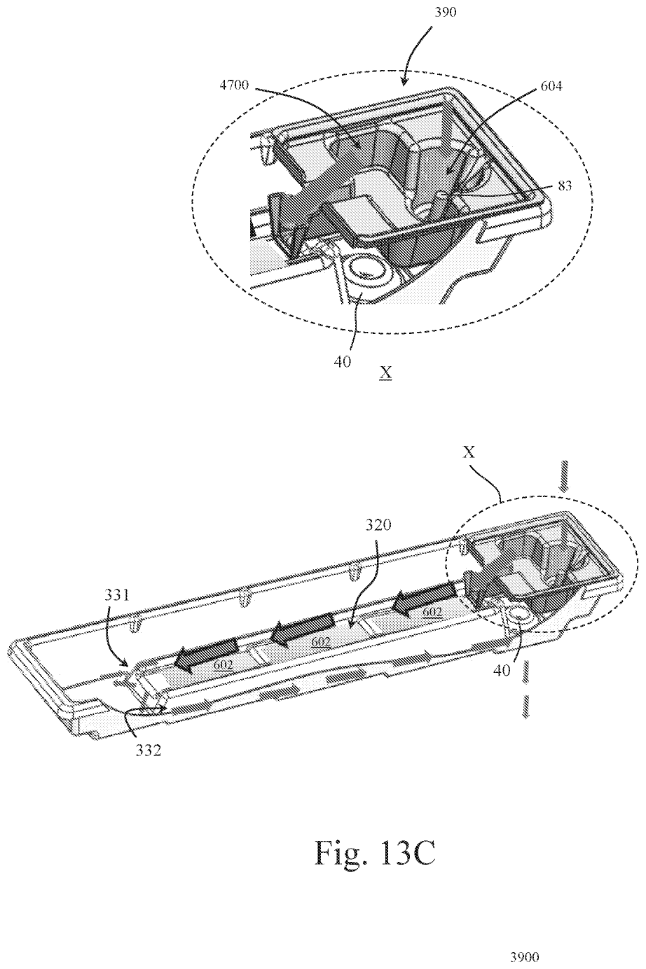

Attention is drawn to FIGS. 8 to 11 illustrating possible embodiments of cassettes and/or interference members that may be envisioned. FIG. 8 exemplifies, inter alia, provision of an interference member 601 here formed as an upstanding wall-like formation at an entry of a cassette. FIGS. 9 and 10 (and later discussed FIG. 13) exemplify, inter alia, provision of a series of interference member 602 here formed as cascade formations forming a series of shallow or step-like waterfalls along the partitions and/or floors of cassettes.

In certain embodiments (see, e.g., two embodied examples at lower right-hand side of FIG. 9)—a cascading interference member 602 may be arranged to comprise reservoir basin(s) 47′ that may hold onto relative small quantities of liquid in an event that liquid flow downstream along terraces (e.g. partition and/or floor) of a cassette may cease, e.g. momentarily and/or for a certain duration of time (e.g. for economy of irrigation/energy). The upper example illustrates formation of such basin(s) 47′ as an indentation or recess formation in a tread 1 surface of cascading interference member 602. The lower example illustrates formation of such basin 47′ by a barrier 2 at or adjacent a downstream side of tread 1 of cascading interference member 602.

FIG. 10 exemplifies possible provision of a modular cassette embodiment, here with a housing of a cassette being formed of two segments. An outer segment 221 including, inter abet, the floor 28 of the cassette and an inner segment 222 arranged to be located within outer segment 221 that may include the cassette's partition 26.

The cassette embodiment of FIG. 10 exemplifies possible provision of such cascade like interference members 602 within a floor and partition of the separate segments here shown—however in a board aspect—provision of such separate segments of a cassette's housing may not necessarily require presence of such interference members 602. For example, this cassette embodiment may include other types of interface members, may be devoid of interference members and/or may be suited to embody other aspects of the present disclosure—such as reservoirs (or the like)

Inner segment 222 in certain cases may be formed from material substantiality suited to absorb light/radiation—in order to reduce or limit undesired formation of biological material within the cassette. Outer segment 221, at least at its outer sides facing out of the cassette's interior—may be formed form materials that substantially reflect back light/radiation impinging thereupon so that light/radiation formed within a hydroponic system may be reflected onwards back towards plants.

Receptacles 97 in this example may be seen embodied formed from material that absorbs light—again to limit light from entering into the cassette that may induce and/or limit formation of undesired biological matter therein.

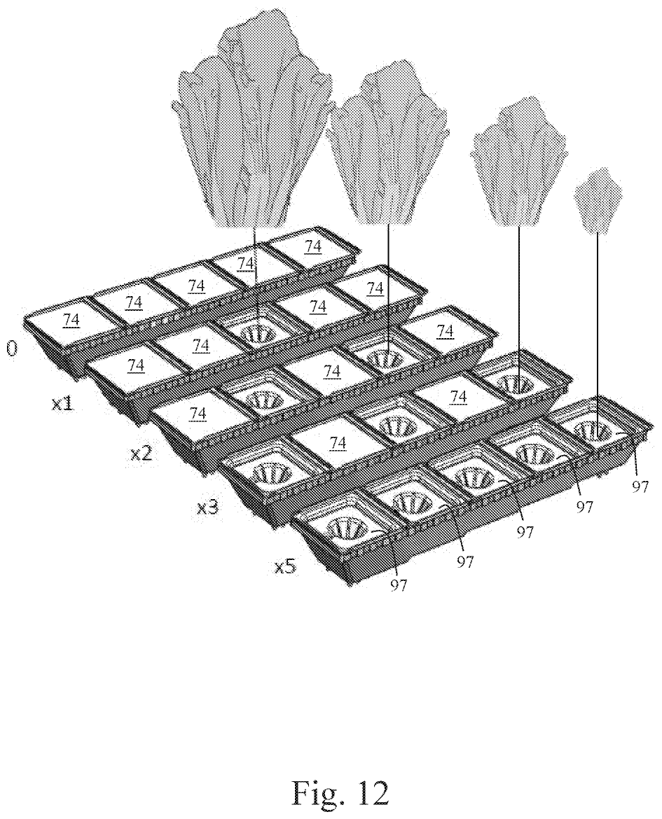

FIG. 11 exemplifies possible opposing bay or arc like interference members 603 here forming a labyrinth for liquid passage along a floor and/or partition of a cassette—for inducing turbulence in liquid flow for purpose of oxygen charging.

Attention is drawn to FIGS. 13A to 13C illustrating further possible embodiments of the present invention. The cassette embodiment here shown may be seen (generally similarly to former embodiments such as in FIGS. 8, 10, 12) being provided with receptacles 97 removably fitted to its upper open side for housing plants and/or supporting growth. A possibility here embodied may be provision of a receptacle like entrance member 390 fitted to a top side of a cassette at or overlaying its entry.

In at least certain embodiments—entrance member 390 may be arranged to combine reservoir and interference functions—here in this optional example illustrated by interference region 604 where incoming liquid entering/falling from above may be arranged to meet a cassette and a reservoir 4700 adjacently downstream. Liquid entering such a cassette may be arranged to engage interference region 604 here seen including an optional upward projection 83 and by that enhance oxygen charging (while possibly also filing a basin at its bottom contributing to “reservoir” character).

From there, liquid flow downstream may fill reservoir 4700—and onwards flow from there downstream (after rising to a certain level defining reservoir 4700)—may be arranged to progress along terraces (e.g. partition and floor) to irrigate plants in such cassette. In this example, the terraces along a first inclined segment 320 (here formed along a central area of the cassette) extending away from entrance member 390 may be seen optionally including cascading interference member 602—however it is to be understood that cassettes embodiments may be arranged to include formations such as entrance member 390 not necessarily with such additional cascading interference formations.

First inclined segment 320 when arriving to adjacent an opposing longitudinal end of the cassette may (in this example) diverge into two opposing flowing second inclined segment 331, 332 that flow and retreat back along opposing lateral sides of the first inclined segment—towards an exit 40 of the cassette. Thus—in this cassette embodiment, the first inclined segment may be seen formed at a relative higher level than the second inclined segment(s)—however exemplified as not necessarily overlaying the second inclined segment(s).

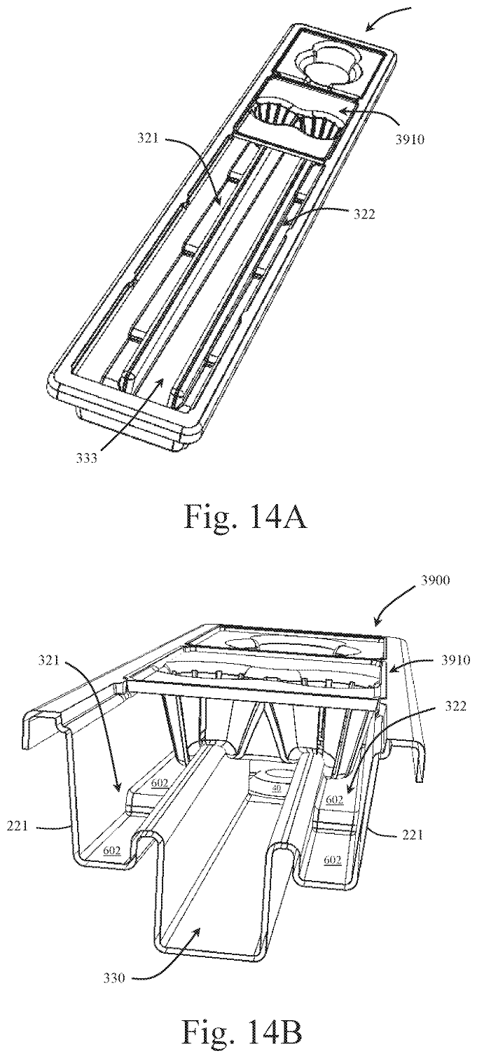

Attention is drawn to FIGS. 14A and 14B illustrating further possible embodiments of the present invention. The cassette embodiment here shown may be seen (generally similarly to former embodiments such as in FIGS. 8, 10, 12, 13) being provided with receptacles 97 removably fitted to its upper open side for housing plants and/or supporting growth. A possibility here embodied may be provision of a receptacle like entrance member 3900 (generally similar to 390) fitted to a top side of a cassette at or overlaying its entry.

In this embodiment—an additional receptacle like diverting member 3910 is seen immediately adjacent entrance member 3900 in a downstream direction. Although members 3900, 3910 are here seen as separate members—in embodiments (not shown) such members may be formed as a similar, possibly integral, member.

In at least certain embodiments—entrance member 3900 may be arranged generally similarly to entrance member 390—to combine reservoir and/or interference functions—while diverting member 3910 may be arranged to divert liquid flowing downstream here into two separate first inclined segment streams 321, 322 arranged to flow along opposing lateral side faces 221 of this cassette—towards an opposing longitudinal side of the cassette. In this example, segments 321, 322 may optionally include—as shown—cascading interference member 602.

This first inclined segments 321, 322 when arriving adjacent the opposing longitudinal end of the cassette may (in this example) converge into an opposing flowing second inclined segment 330 that flows and retreats back along a central portion of the cassette towards an exit 40 of the cassette. Thus—in this cassette embodiment, the first inclined segments 321, 322 may be seen formed at a relative higher level than the second inclined segment 330—however exemplified as not necessarily overlaying the second inclined segment—(as is generally the case in the former embodiment of FIG. 13).

Attention is drawn back to FIG. 6 for further attention to possible formation of a reservoir 470 here adjacent exit 40 of a cassette. In the illustrated example, reservoir 470 may be seen being formed by raising exit 40 above regions of floor 28 adjacent a rear end of the floor.

Attention is drawn to FIG. 7 illustrating possible provision of a liquid absorbing material 55 along at least portions of the liquid path through a cassette. Such absorbing material 55, possibly formed from material having wicking and/or capillary properties such as textile or the like, may be arranged to communicate between reservoir(s) formed in a cassette and areas along the cassette where in access to roots of plants growing in the cassette.

In this example, liquid absorbing material 55 is seen communicating between a reservoir 470 formed adjacent exit 40—however such absorbing material 55 may be arranged to communicate liquid towards roots of plants along a cassette (e.g. along a partition 26 of a cassette) from reservoirs located in other areas of a cassette, such as from reservoir 47 located at an entry to a cassette.

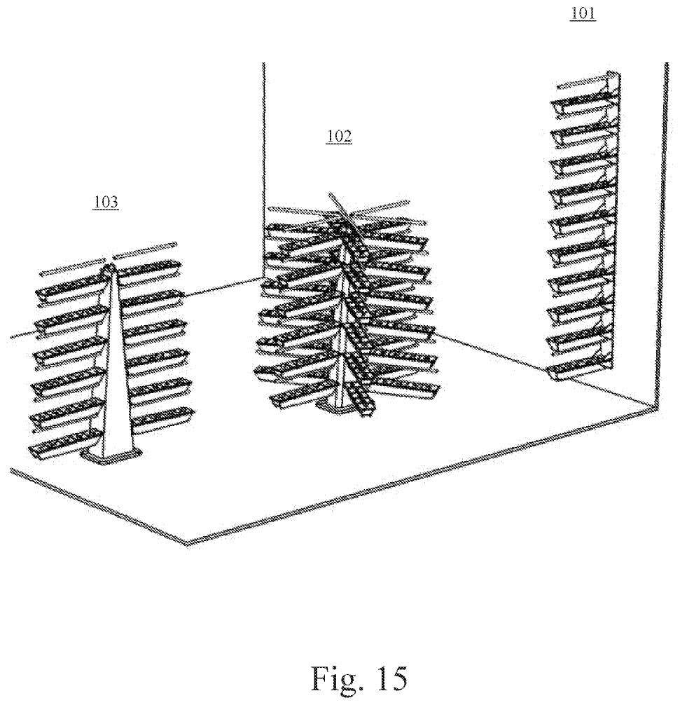

Attention is drawn to FIG. 15 illustrating further possible embodiments of hydroponic systems—that may include embodiments of cassettes for growing plants—as described herein. The embodiment of hydroponic system 101 exemplifies cassettes possibly fitted to a wall that may be arranged to extend substantially perpendicularly away from the wall one above the other.

The embodiment of hydroponic system 102 exemplifies cassettes possibly fitted to a central post—and arranged about the post to extend away therefrom in groups one above the other. The embodiment of hydroponic system 103 exemplifies cassettes possibly fitted again to a post—here extending away in two directions away for the post.

The embodiments of hydroponic systems 101, 102, 103 may be suited within respective dedicated shielding structures (not shown), such as cabinet 12 that may be seen as serving as an outer shielding structure in hydroponic system 10. In some cases, the embodiments of hydroponic systems 101, 102, 103 may also be seen exemplifying use of systems not necessarily located within such dedicated outer shielding structures—that may be fitted within a dwelling or a vicinity of a dwelling for growing plants.

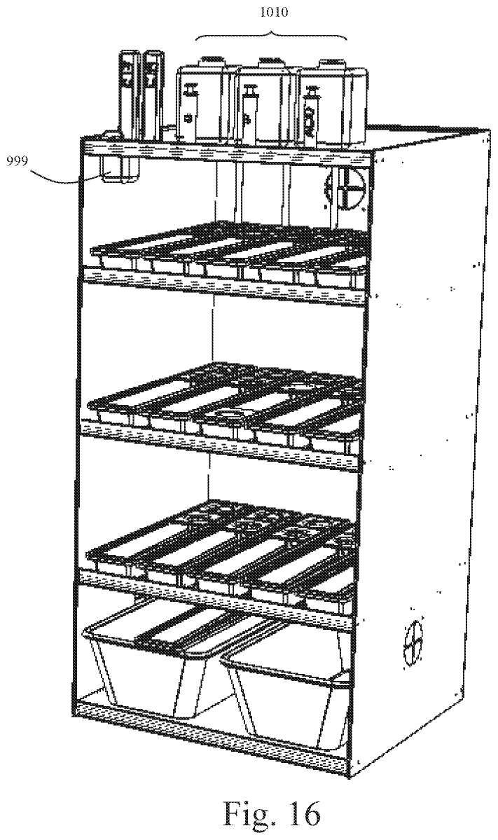

With attention drawn to FIG. 16—a hydroponic system is shown including a liquid container 999 at an upper side. Liquid flowing through cassettes of the system may be pumped upwards to be directed back towards the cassette—while a certain liquid portion may be diverted to flow to container 999. At container 999—measurements may be permitted of the liquid parameters of parameters, such as: EC, conductivity, PH (or the like).

Provision of this location for measurements may be useful since it is at a location more conveniently accessible to a user of the system (as opposed e.g., to basin 99 at the lower side of such a system). In addition, adjacent container 999 may be located tank 1010 like members including additives that may be added to liquid flowing through the system—and possible pumps such as syringes—suitable for administrating such additives into container liquid in the system.

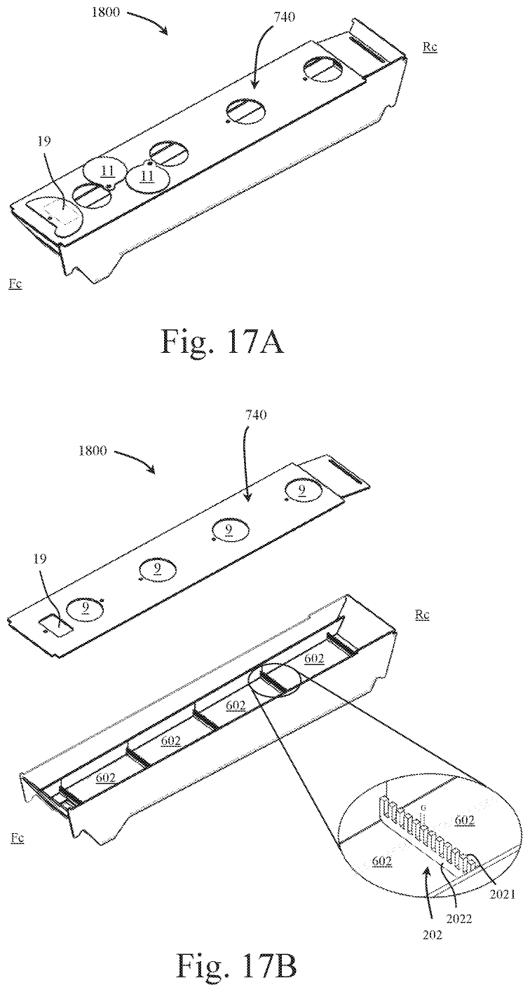

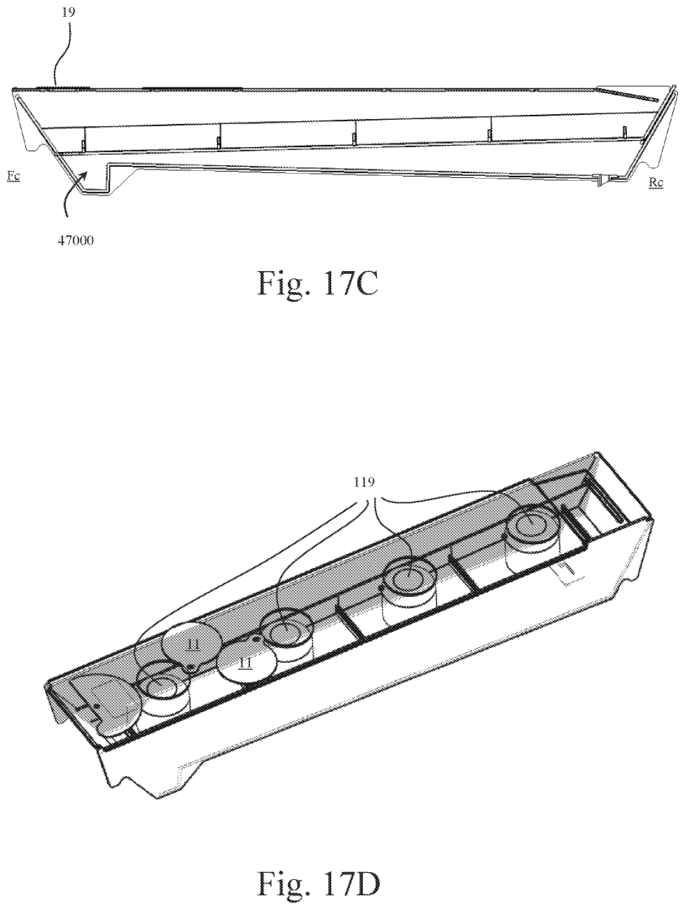

Attention is drawn to FIGS. 17A and 17D illustrating an embodiment of a growing cassette 1800. Growing cassette 1800 in this example may be arranged to include a lid or cover member 740 covering an upper opening/side of the cassette. The cover member here includes apertures 9 through which access may be available to plats within cassette and caps 11 that are attached to the cover member and movable to close or open each aperture.

In this example, the caps 11 are hinged to the cover and can be pivoted into place above each aperture e.g. when not in use, when covering a plant in early seed stages (or the like). The cover member may also include an openable hatch 19 here at a front side F_{C} of the cassette. Hatch 19 may be used e.g. for introduction of instruments into the cassette in order to measure conditions within the cassette such as PH of a liquid solution within the cassette.

In FIG. 17B the cassette is shown formed with a series of interference members 602 here formed as cascade formations forming a series of shallow or step-like waterfalls along the partitions and/or floors of the cassette. The enlarged section in FIG. 17B reveals possible formation of a filter-like barrier 202 that may be formed in-between adjacent cascades 602.

Filter-like barrier 202 in this example can be seen having a comb-like structure with narrow teeth 2021 projecting upwards from a common base 2022 that extends along a width of the cascades 602. The filter-like barriers 202 may be useful in capturing dirt carried by water flowing through a cassette, and in one example a gap G between adjacent teeth in a barrier may vary in the downstream direction of flow through a cassette from one barrier to the next, for example may decrease.

Attention is drawn to FIG. 17C schematically illustrating a longitudinal cross section of a cassette generally similar to the one shown in FIGS. 17A and 17B. Here, the cassette is shown including a reservoir 47000 adjacent a front side Fc of the cassette. Reservoir 47000 in this position just below hatch 19 may be useful in providing a zone where measurements may be conducted to a solution flowing within the cassette to ensure e.g. suitable conditions for plant growth.

A measurement instrument inserted through hatch 19 may be placed within reservoir 47000 to conduct such measurements. Positioning of the reservoir at the front more accessible side of the cassette may ease execution of such measurements without need to remove the cassette e.g. from within a growing cabinet.

Attention is drawn to FIG. 17D illustrating use of growing media pods 119 within the cassette. The pods 119 can be of various sizes and material, such as foam, rock-wool, coconut fiber, peat-moss (and the like). On each pod a few seeds may be placed and in time e.g. the strongest plant may be chosen to stay on. During the germination period, a few of these pods could be placed in one level and covered by caps 11 to keep the seeds in the dark. After sprouting, each pod may be relocated to another cassette so that there is one pod (plant) per level (hole in the cover).

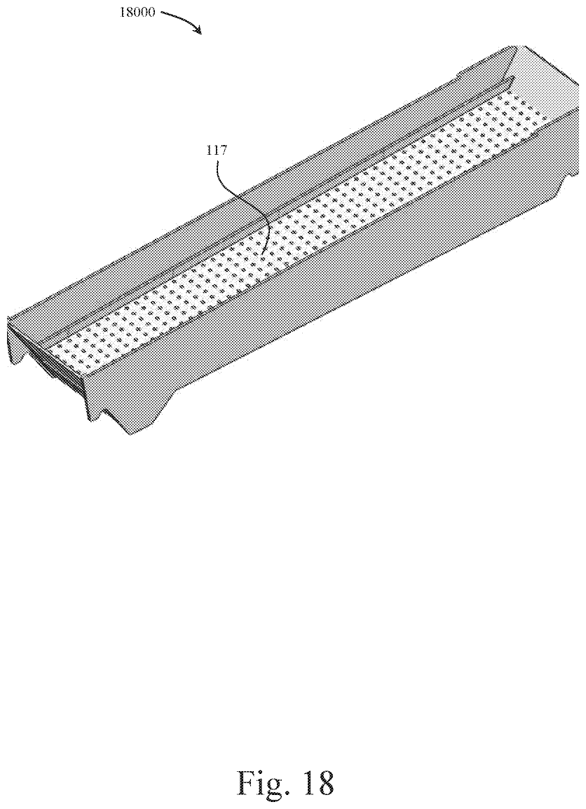

Attention is drawn to FIG. 18 illustrating an embodiment of a cassette 18000 exemplifying use of a mesh 117 suitable for wicking water up from a floor of the cassette upon which it is placed. Mesh 117 may be formed from various materials (e.g. woven fabric, geo-textile, etc.) and seeds may be dispersed upon the mesh to support seedling development.

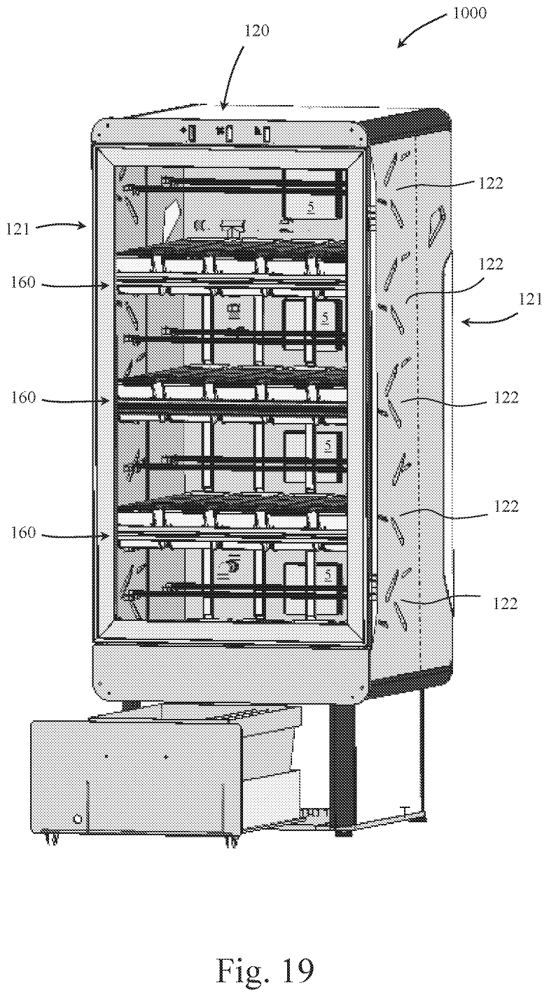

Attention is drawn to FIG. 19 exemplifying a hydroponic system 1000 generally similar to those described herein, such as in FIGS. 1 and 16. Hydroponic system 1000 is arranged to include shelf formations 160 in which cassette embodiments (such as any one of those described herein) may be placed. Hydroponic system 1000 includes a closet-like cabinet 120 with opposing side walls 121 each formed with openings 122 through which air can circulate in an out of the cabinet.

The openings 122 are here shown being formed on the side walls towards a forward side of the cabinet substantially beyond a center line of a side wall (see such center line marked by the ‘dashed-dotted’ line in this figure). Further seen in this figure are possible fan formations 5 that may be placed on a rear side of the cabinet. In this example, the fan formations are optionally located above and below shelf formation 160 (e.g. in-between shelf formations) to urge air rearwardly out of the cabinet, while drawing fresh air from the ambient environment outside of the cabinet into the cabinet via the openings. Placement of the openings towards a forward side of a side wall ensures that fresh incoming flow of air passes along a substantial full extension of each cassette to interact with plants growing in the cassettes before being urged back out of the cabinet.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology; from a study of the drawings, the technology and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A cassette for supporting hydroponic growth of plants, the cassette comprising an inlet, an outlet and a flow path communicating between the inlet and outlet, wherein the inlet and outlet are arranged at a similar gating side of the cassette generally adjacent one to the other.

2. The cassette of claim 1 and having an elongated formation extending between opposing longitudinal sides, and the gating side where inlet and outlet are arranged is at one of the longitudinal sides.

3. The cassette of claim 2, wherein the flow path communicating between the inlet and outlet comprises first and second segments, wherein the first segment extends away from the inlet and/or the gating side and the second segment extends back towards the outlet and/or the gating side.

4. The cassette of claim 3, wherein the first and second segments extend transverse one to the other, possibly along routes that are inclined relative to each other.

5. (canceled)

6. The cassette of claim 1, wherein the inlet is located generally above the outlet, and
wherein the flow path extends back and forth along the cassette.

7. (canceled)

8. The cassette of claim 6, wherein the second segment of the flow path comprises two sub-segments extending along lateral sides of the cassette back towards the outlet, and the first segment doesn't overlie the two sub-segments.

9. The cassette of claim 6, wherein the first segment of the flow path comprises two sub-segments extending along lateral sides of the cassette away from the inlet, and the two sub-segments don't overlie the second segment.

10.-13. (canceled)

14. The cassette of claim 1 and comprising at least one interference member along the flow path for interfering/interacting with the flow of liquid passing through the cassette, wherein
the at least one interference member induces turbulence in liquid flowing there-through or there-along,
or wherein the at least one interference member is at least one of: a bulging structure, a series of cascades, a series of structures forming a labyrinth for liquid to flow therethrough.

15.-26. (canceled)

27. A hydroponic system comprising a plurality of cassettes for growing plants, each cassette comprising an inlet and an outlet arranged at a similar gating side of the cassette, wherein all cassettes of the system are aligned with their respective gating sides generally at a similar side of the system.

28. The hydroponic system of claim 27 and comprising an opening at a forward side of the system for accessing an interior of the system, wherein the gating sides of all cassettes are not located at or adjacent the forward side of the system, for example at an opposing rear side of the system.

29. The hydroponic system of claim 27, wherein cassettes in the system are arranged in cassette groups each comprising a vertical stack of cassettes located one above the other, and during an irrigation cycle the system comprising a continuous liquid flow route between cassettes of each given cassette group.

30. The hydroponic system of claim 29, wherein cassettes of a given cassette group are vertically spaced apart, and the liquid flow route of each a given cassette group flows falling downwards along a bridging flow path bridging the spaces between vertically adjacent cassettes of the given cassette group.

31. The hydroponic system of claim 30, wherein bridging flow paths enter cassettes at their respective inlets and/or exits cassettes at their respective outlets.

32. The hydroponic system of claim 31, wherein each cassette comprises a flow path extending between the inlet and outlet.

33. The hydroponic system of claim 32, wherein the flow path communicates between the inlet and outlet and comprises first and second segments, wherein the first segment extends away from the inlet and/or the gating side and the second segment extends back towards the outlet and/or the gating side.

34. The hydroponic system of claim 33, wherein the first and second segments extend transverse one to the other, possibly along routes that are inclined relative to each other.

35. The hydroponic system of claim 34, wherein the first segment is located above the second segment.

36. The hydroponic system of claim 35, wherein in each cassette the inlet is located generally above the outlet.

37. A method for hydroponic growth of plants comprising the steps of:
providing a plurality of cassettes for growing plants each comprising an inlet and an outlet arranged at a similar gating side of the cassette, wherein cassettes are arranged one above the other with their respective gating sides aligned generally one on top of the other, and
providing a liquid flow entering the upper most cassette to continuously flow from there downstream through all the cassettes.

38. The method of claim 37, wherein liquid flowing out of an outlet of a cassette drops vertically downwards into an inlet of an adjacently below cassette.

39-49. (canceled)
